(19) United States
(12) Patent Application Publication
(10) Pub. No.: US 2026/0359900 A1
(43) Pub. Date: Nov. 12, 2026

(54) USER TRACING IN PRIVACY-PRESERVING ANONYMOUS TRANSACTION SYSTEMS

(71) Applicant: INTERNATIONAL BUSINESS MACHINES CORPORATION, Armonk, NY (US)

(72) Inventors: Elina Van Kempen, Saint Remy (FR); Rebekah Mercer, Zurich (CH); Angelo De Caro, Zurich (CH); Elli Androulaki, Zurich (CH); Kaoutar El Khiyaoui, Zurich (CH)

(21) Appl. No.: 19/199,762

(22) Filed: May 6, 2025

(51) Int. Cl. G06Q 40/12

(52) U.S. Cl. CPC G06Q 40/12

(57) ABSTRACT

A method includes generating, by a user device, an epoch-based tag generation key for a current epoch and a unique tag for a transaction using the epoch-based tag generation key and generating a zero-knowledge proof to demonstrate validity of the unique tag without revealing user identity. The transaction is transmitted with the unique tag and zero-knowledge proof to a ledger. The ledger verifies that the unique tag does not match any previous transaction tags. The transaction is recorded on the ledger if the unique tag and zero-knowledge proof are verified. Retrieval of user-specific transactions is enabled for auditing purposes based on the unique tags.

### BACKGROUND

The present invention generally relates to transaction auditing systems and more particularly to systems and methods which can trace user transactions while preserving privacy of the user.

In a transaction system with n users, a history of user transactions can be kept through a public ledger. The privacy and anonymity of the users is preserved in the published ledger. However, if malicious behavior from a user is suspected, an audit may be executed to recover and study that user's data. To efficiently audit a targeted user's data, it is necessary to efficiently trace the users. An auditor should not have to go through all existing logs to recover a specific user's transactions but should be able to quickly retrieve all past transactions from the targeted user. Even with efficient tracing and auditing of users, the privacy of the user should not be compromised when the user is not the object of the audit.

In conventional systems, storage needs by auditors include at least one secret/key per user. Processing of auditor queries is often by sequential data computation only. This leads to inefficiency for auditors as it slows down the process. Once authorized to audit a user, the user loses privacy as the user's transactions can be audited for an indefinite amount of time. In other words, once a user is audited once, the auditor has the ability to audit this user's transactions forever. In addition, auditors, once set, cannot be easily changed.

Further, in conventional systems, the auditor often needs to interact directly with the audited user. This requires knowing the identity of the audited user by the auditor and support personnel of the auditor. Fine-grained auditing (user specific) is often limited by the auditing process since identifying all transactions for each individual user can be difficult to track.

Therefore, a need exists for privacy-preserving and efficient user tracing methods for transactions by auditors.

### SUMMARY

In accordance with an embodiment of the present invention, a method includes generating, by a user device, an epoch-based tag generation key for a current epoch and a unique tag for a transaction using the epoch-based tag generation key and generating a zero-knowledge proof to demonstrate validity of the unique tag without revealing user identity. The transaction is transmitted with the unique tag and zero-knowledge proof to a ledger. The ledger verifies that the unique tag does not match any previous transaction tags. The transaction is recorded on the ledger if the unique tag and zero-knowledge proof are verified. Retrieval of user-specific transactions is enabled for auditing purposes based on the unique tags.

In other embodiments, computing the unique tag can include sampling a random value and combining the random value with the epoch-based tag generation key. The epoch-based tag generation key can be derived using a key derivation function based on a user tag key and an epoch number. A number of transactions per user per epoch can be limited to a predefined maximum value. The enabling retrieval of user-specific transactions can include receiving, by an auditor, a user tag key for a specific user and epoch from an intermediary; computing possible tags for the specific user and epoch; and retrieving transactions from the ledger matching the possible tags. The method can include verifying, by the auditor, that the user tag key corresponds to a target user identifier.

The transaction can include an Unspent Transaction Output (UTXO) based transaction, and the method can further include generating a hiding commitment for each token in an array of tokens, wherein the hiding commitment includes a unique identifier of an owner, a value, and a serial number. The method can further include generating a zero-knowledge proof demonstrating that a sum value of inputs matches a sum value of outputs without revealing specific values; and revealing the serial number when spending an input token to enable detection of double spending. The computing the unique tag can include generating a sender tag for each input of the UTXO based transaction; and generating a recipient tag for each output of the UTXO based transaction. The method can further include proving that each recipient tag refers to an identity stored in a corresponding output commitment without revealing the identity. An intermediary can generate the recipient tag on behalf of a recipient when the recipient is not online.

In accordance with another embodiment of the present invention, a system includes a processor set, one or more computer-readable storage media and program instructions stored on the one or more computer-readable storage media to cause the processor set to perform operations. The operations include generating an epoch-based tag generation key for a current epoch; computing a unique tag for a transaction using the epoch-based tag generation key; appending the unique tag to the transaction; transmitting the transaction with the appended unique tag to a ledger; verifying that the unique tag does not match any previous transaction tags stored on the ledger; and enabling retrieval of user-specific transactions for auditing purposes based on the unique tags.

In other embodiments, the operations can include generating a zero-knowledge proof demonstrating validity of the unique tag without revealing user identity. The operations can further include limiting a number of transactions per user per epoch to a predefined maximum value. Enabling retrieval of user-specific transactions can include receiving a user tag key for a specific user and epoch from an intermediary; computing possible tags for the specific user and epoch; and retrieving transactions from the ledger matching the possible tags. The operations can include verifying that the user tag key corresponds to a target user identifier. The unique tag can be computed by generating a sender tag for each input of an Unspent Transaction Output (UTXO) based transaction; and generating a recipient tag for each output of the UTXO based transaction. The system can prove that each recipient tag refers to an identity stored in a corresponding output commitment without revealing the identity. An intermediary can generate the recipient tag on behalf of a recipient when the recipient is not online.

In accordance with another embodiment of the present invention, a computer program product includes one or more computer-readable storage media; and program instructions stored on the one or more computer-readable storage media to perform operations. The operations include generating an epoch-based tag generation key for a current epoch; computing a unique tag for a transaction using the epoch-based tag generation key; appending the unique tag to the transaction; transmitting the transaction with the appended unique tag to a ledger; verifying that the unique tag does not match any previous transaction tags stored on the ledger; and enabling retrieval of user-specific transactions for auditing purposes based on the unique tags.

In other embodiments, the operations can include generating a zero-knowledge proof demonstrating validity of the unique tag without revealing user identity. The operations can further include limiting a number of transactions per user per epoch to a predefined maximum value. Enabling retrieval of user-specific transactions can include receiving a user tag key for a specific user and epoch from an intermediary; computing possible tags for the specific user and epoch; and retrieving transactions from the ledger matching the possible tags. The operations can include verifying that the user tag key corresponds to a target user identifier. The unique tag can be computed by generating a sender tag for each input of an Unspent Transaction Output (UTXO) based transaction; and generating a recipient tag for each output of the UTXO based transaction. The computer program product can prove that each recipient tag refers to an identity stored in a corresponding output commitment without revealing the identity. An intermediary can generate the recipient tag on behalf of a recipient when the recipient is not online.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block/flow diagram showing a method for user tracing in privacy-preserving anonymous transaction systems, in accordance with an embodiment of the present invention;

FIG. 2 is a block/flow diagram showing a system for user tracing in privacy-preserving anonymous transaction systems, in accordance with an embodiment of the present invention;

FIG. 3 is a block/flow diagram showing transactions where there are senders and recipients, in accordance with an embodiment of the present invention;

FIG. 4 is a block diagram showing a computer environment for user tracing in privacy-preserving anonymous transaction systems, in accordance with an embodiment of the present invention; and

FIG. 5 is a block/flow diagram showing methods for user tracing in privacy-preserving anonymous transaction systems, in accordance with an embodiment of the present invention.

### DETAILED DESCRIPTION

In accordance with embodiments of the present invention, systems and methods for efficient and privacy-preserving audits are provided. Efficiency is provided by having low memory storage needs. For example, an auditor does not have to store anything prior to auditing a user. In addition, efficient computations can be achieved since the auditor only needs to compute xₘₐₓ tags and can quickly look up relevant transactions for a specific user instead of needing to review an entire ledger. Further, efficient transaction processing is achieved since an index or epoch system permits parallelism for the review of transactions.

Privacy preservation is achieved through security and privacy guarantees. These can include unlinkability, unframeability and no tag duplication within the auditing process. Fine-grained auditing is provided, but the auditor cannot compute the tags of a user that is not part of an authorized audit. In addition, an auditor can only audit a user for a given time period or epoch, and not for an indefinite amount of time (e.g., forever). Auditing can be fine-grained, permitting auditing specific to a single user.

In accordance with embodiments of the present invention, systems and methods are provided for efficient and privacy-preserving auditing of transactions in anonymous transaction systems. Embodiments of the present invention can enable auditors to trace and audit user transactions while maintaining user privacy and system efficiency. In some embodiments, the systems and methods can utilize a verifiable tagging scheme that allows users to append tags to their transactions. These tags can be computed efficiently by auditors during an audit to retrieve a user's past transactions without compromising the privacy and security properties of the underlying transaction system.

Embodiments of the present invention can implement an epoch-based approach, where transactions are grouped into time periods or epochs. This approach permits for bounded auditing, as auditors can only access user data for specific epochs rather than indefinitely. The number of transactions per user per epoch may be limited by a public parameter.

Embodiments of the present invention can provide computationally efficient generation of tracing information, low storage requirements for auditors, preservation of user privacy and anonymity, non-deniability of transactions, unframeability of users, and limited auditor power. These features enable fine-grained auditing specific to individual users while maintaining the integrity and efficiency of the transaction system.

All requested data can accurately and correctly be obtained by an auditor without having to review all entries of a ledger. This provides computationally efficient generation of tracing information by users as the tracing scheme will not slow an underlying system that it serves. The privacy of users is maintained. In addition to anonymity, unlinkability is provided to preserve the same privacy properties as those of the underlying system. Users cannot deny/hide the existence of data involving them. Users are not able to pass as another user (unframeability). Auditing power is limited to only a user's data from a specific time frame. An efficient verifiable tagging scheme is provided for anonymous transaction systems. For each transaction, the user computes and appends a tag. At time of audit, the auditor efficiently computes the user's tags and retrieves the user's past transactions. The tags preserve the privacy and security properties of the underlying transaction system, e.g., unlinkability, no duplication of transactions, pseudo randomness. The scheme is epoch-based. In each epoch, only a certain number of transactions can be submitted by a given user. The auditor performs linear computation in a maximum number of transactions per epoch per user. Auditing parameters include an epoch and a bounded Index (xₘₐₓ), which is a maximum number of transactions per user per epoch. xₘₐₓ is a public parameter known to everyone.

In accordance with embodiments of the present invention, methods and systems are provided that preserve user privacy during audits and make the audit process more efficient for auditors. A method includes generating, by a user device, an epoch-based tag generation key for a current epoch and a unique tag for a transaction using the epoch-based tag generation key and generating a zero-knowledge proof to demonstrate validity of the unique tag without revealing user identity. The transaction is transmitted with the unique tag and zero-knowledge proof to a ledger. The ledger verifies that the unique tag does not match any previous transaction tags. The transaction is recorded on the ledger if the unique tag and zero-knowledge proof are verified. Retrieval of user-specific transactions is enabled for auditing purposes based on the unique tags. In this way, an auditor does not have to store anything prior to auditing a user and efficient computations can be achieved since the auditor only needs to compute xₘₐₓ tags and can quickly look up relevant transactions for a specific user instead of needing to review an entire ledger. Further, efficient transaction processing is achieved since an index or epoch system permits parallelism for the review of transactions. Privacy preservation is achieved through security and privacy guarantees. The auditor cannot compute the tags of a user that is not part of an authorized audit. In addition, an auditor can only audit a user for a given time period or epoch, and not for an indefinite amount of time.

In other embodiments, computing the unique tag can include sampling a random value and combining the random value with the epoch-based tag generation key. The epoch-based tag generation key can be derived using a key derivation function based on a user tag key and an epoch number. A number of transactions per user per epoch can be limited to a predefined maximum value. The enabling retrieval of user-specific transactions can include receiving, by an auditor, a user tag key for a specific user and epoch from an intermediary; computing possible tags for the specific user and epoch; and retrieving transactions from the ledger matching the possible tags. The method can include verifying, by the auditor, that the user tag key corresponds to a target user identifier.

The transaction can include an Unspent Transaction Output (UTXO) based transaction, and the methods can further include generating a hiding commitment for each token in an array of tokens, wherein the hiding commitment includes a unique identifier of an owner, a value, and a serial number. The methods can further include generating a zero-knowledge proof demonstrating that a sum value of inputs matches a sum value of outputs without revealing specific values; and revealing the serial number when spending an input token to enable detection of double spending. The computing the unique tag can include generating a sender tag for each input of the UTXO based transaction; and generating a recipient tag for each output of the UTXO based transaction. The method can further include proving that each recipient tag refers to an identity stored in a corresponding output commitment without revealing the identity. An intermediary can generate the recipient tag on behalf of a recipient when the recipient is not online.

In accordance with another embodiment of the present invention, a system includes a processor set, one or more computer-readable storage media and program instructions stored on the one or more computer-readable storage media to cause the processor set to perform operations. The operations include generating an epoch-based tag generation key for a current epoch; computing a unique tag for a transaction using the epoch-based tag generation key; appending the unique tag to the transaction; transmitting the transaction with the appended unique tag to a ledger; verifying that the unique tag does not match any previous transaction tags stored on the ledger; and enabling retrieval of user-specific transactions for auditing purposes based on the unique tags.

As before, an auditor does not have to store anything prior to auditing a user and efficient computations can be achieved since the auditor only needs to compute xₘₐₓ tags and can quickly look up relevant transactions for a specific user instead of needing to review an entire ledger. Further, efficient transaction processing is achieved since an index or epoch system permits parallelism for the review of transactions. Privacy preservation is achieved through security and privacy guarantees. The auditor cannot compute the tags of a user that is not part of an authorized audit. In addition, an auditor can only audit a user for a given time period or epoch, and not for an indefinite amount of time.

In other embodiments, the operations can include generating a zero-knowledge proof demonstrating validity of the unique tag without revealing user identity. The operations can further include limiting a number of transactions per user per epoch to a predefined maximum value. Enabling retrieval of user-specific transactions can include receiving a user tag key for a specific user and epoch from an intermediary; computing possible tags for the specific user and epoch; and retrieving transactions from the ledger matching the possible tags. The operations can include verifying that the user tag key corresponds to a target user identifier.

If UTXO transactions are employed, the unique tag can be computed by generating a sender tag for each input of a UTXO based transaction; and generating a recipient tag for each output of the UTXO based transaction. The system can prove that each recipient tag refers to an identity stored in a corresponding output commitment without revealing the identity. An intermediary can generate the recipient tag on behalf of a recipient when the recipient is not online.

In accordance with another embodiment of the present invention, a computer program product includes one or more computer-readable storage media; and program instructions stored on the one or more computer-readable storage media to perform operations. The operations include generating an epoch-based tag generation key for a current epoch; computing a unique tag for a transaction using the epoch-based tag generation key; appending the unique tag to the transaction; transmitting the transaction with the appended unique tag to a ledger; verifying that the unique tag does not match any previous transaction tags stored on the ledger; and enabling retrieval of user-specific transactions for auditing purposes based on the unique tags.

In other embodiments, the operations can include generating a zero-knowledge proof demonstrating validity of the unique tag without revealing user identity. The operations can further include limiting a number of transactions per user per epoch to a predefined maximum value. Enabling retrieval of user-specific transactions can include receiving a user tag key for a specific user and epoch from an intermediary; computing possible tags for the specific user and epoch; and retrieving transactions from the ledger matching the possible tags. The operations can include verifying that the user tag key corresponds to a target user identifier. The unique tag can be computed by generating a sender tag for each input of a UTXO based transaction; and generating a recipient tag for each output of the UTXO based transaction. The computer program product can prove that each recipient tag refers to an identity stored in a corresponding output commitment without revealing the identity. An intermediary can generate the recipient tag on behalf of a recipient when the recipient is not online.

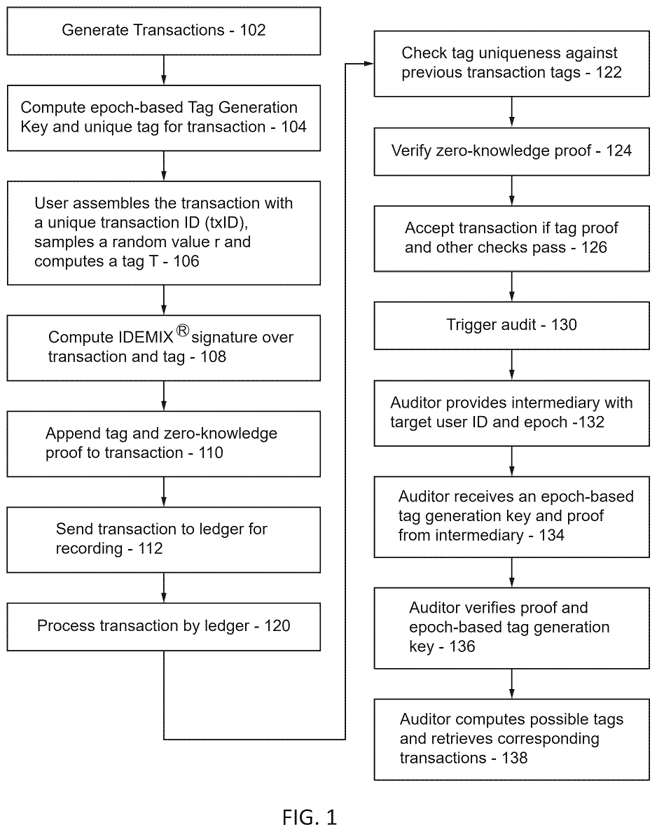

Referring now to the drawings in which like-numerals represent the same or similar elements and initially to FIG. 1, methods where user transactions are developed and audited are illustrated in accordance with embodiments of the present invention. In block 102, transactions are generated. Transactions can refer to any exchange, transfer, or interaction involving digital assets, information, or value between two or more parties within a system. Transactions may be recorded on a distributed ledger or blockchain and may include various types of data such as sender and recipient identifiers, timestamps, amounts, and cryptographic signatures. Possible scenarios where transactions can occur can include, e.g., financial transfers between users, smart contract executions, token issuance or redemption, asset exchanges or trades, data sharing or access grants, voting or governance actions, identity verification or attestations, supply chain updates or logistics tracking, intellectual property registrations or licensing, healthcare record updates or access permissions, energy trading or consumption reporting, real estate title transfers or property registrations, educational credential issuance or verification, insurance claim processing or policy updates, carbon credit trading or emissions reporting, digital content licensing or royalty payments, cross-border remittances or currency exchanges, loyalty point issuance, redemption, or transfers, etc.

In block 104, at the beginning of each epoch, the user computes an epoch-based Tag Generation Key: TGKe=KDF (UTK,e), where TGKₑ is the Tag Generation Key for epoch e, KDF is a Key Derivation Function, UTK is the User Tag Key and e is the epoch number. When preparing a transaction, the user assembles the transaction with a unique transaction ID (txID), samples a random value r and computes a tag T where T=TGKₑᵣ, which is indexed TGK by e and r, representing an output of a function with input TGKₑ and random number r, in block 106. In block 108, the user computes, e.g., an IDEMIX® signature over the transaction and tag T, committing to their user ID (UID). IDEMIX® is an anonymous credential system where each credential is bound to a given set of attributes. IDEMIX® is a cryptographic protocol suite, which provides strong authentication as well as privacy-preserving features.

In block 108, the user proves in zero-knowledge that T=TGKₑᵣ∨TGKₑ=KDF (UTK,e). In block 110, the user appends the tag T and proof x to the transaction along with the IDEMIX® signature. In block 112, the user sends the transaction to a ledger for recording.

In block 120, transaction processing is performed by the ledger. The ledger checks that tag T does not match any previous transaction tags in block 122. The ledger also verifies the zero-knowledge proof x in block 124. In block 126, the ledger accepts the transaction if the tag proof is verified and other required checks pass.

In block 130, an audit is triggered. In block 132, to determine a user's transactions, an auditor provides an intermediary with the target UID of the user and an epoch e. In block 134, the auditor receives from the intermediary an epoch-based Tag Generation Key (TGKₑ), and a proof that the TGKₑ corresponds to the target UID. In block 136, the auditor verifies the proof and the epoch-based Tag Generation Key.

In block 138, the auditor computes all possible tags for the target epoch, e.g., for each i in {1, . . . , xₘₐₓ}, where xₘₐₓ is a bounded index (maximum number of transactions per user per epoch): Tᵢ=TGKₑᵢ. The auditor performs a lookup over the ledger for each computed Tᵢ to retrieve corresponding transactions which are specific for the audited or targeted user only and only within the specific epoch. This allows the auditor to efficiently retrieve all transactions submitted by the targeted user in the specified epoch without compromising the privacy of other users or transactions outside the audited epoch. The use of epoch-based tag generation and bounded indices enables fine-grained auditing while maintaining system efficiency and user privacy.

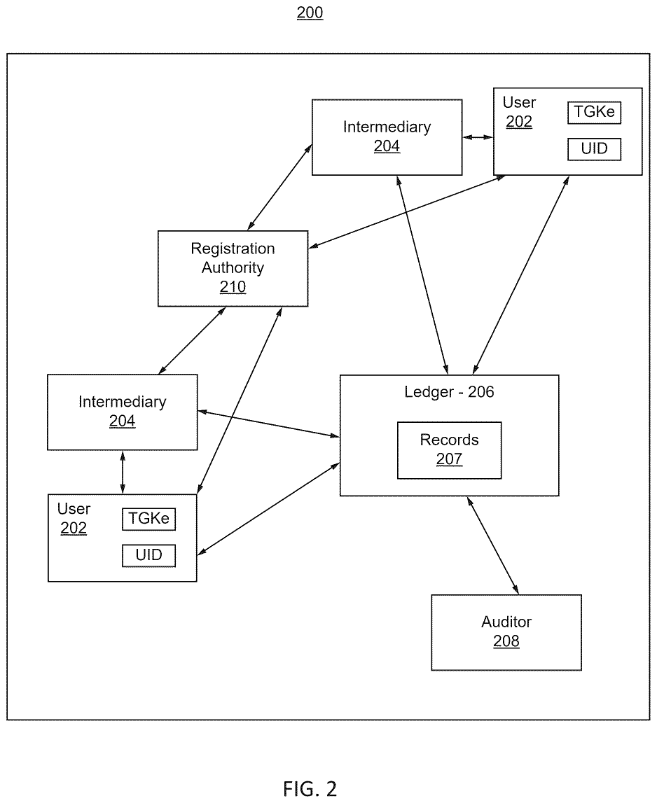

Referring to FIG. 2, a transaction system 200 is shown in accordance with an embodiment of the present invention. The transaction system 200 includes a plurality of users 202 where each user includes a user computing device for carrying out transactions. Each user 202 can initiate and participate in transactions, can compute epoch-based Tag Generation Keys (TGK) for each epoch, can generate unique tags for each transaction and can create zero-knowledge proofs to demonstrate the validity of tags. The users perform transactions with each other, and each has an intermediary 204. Each user 202 is also equipped with a unique identifier UID. Each user 202 can sign transactions using anonymous credentials (e.g., IDEMIX®) and communicate with the intermediaries 204 to register and obtain necessary credentials.

A ledger 206, which can include a public ledger, can store transaction records 207 in a distributed and permissioned manner. In an embodiment, the ledger 206 can include a hyperledger fabric, which supports IDEMIX®. Each user 202 must sign a transaction for the transaction to be considered admissible to the ledger 206. Each transaction on the ledger 206 carries a unique identifier, TxID. The ledger 206 guarantees no duplication of transaction IDs. IDEMIX® is an anonymous credential system where each credential is bound to a given set of attributes. A user equipped with such a credential generates unlinkable and anonymous pseudonyms (e.g., no attribute is revealed unless explicitly required). With a pseudonym, the user 202 generates a signature over any message. In addition, the user attaches to the signature a commitment to any of their attributes.

This can include verifying the uniqueness of transaction tags and validation of the zero-knowledge proofs associated with transactions. The ledger 206 can ensure that each transaction is properly signed by each user 202. The ledger 206 assigns the unique transaction identifiers (TxID) to each valid transaction. This further supports anonymous credential systems (e.g., IDEMIX®) and can permit parallel processing of transactions within epochs.

An auditor 208, which can include a computing device and can audit users when authorized. The auditor 208 can request audit information for specific users and epochs from intermediaries 204. The auditor 208 does not store any secret key. The auditor 208 can verify proofs provided by the intermediaries 204. The auditor 208 computes all possible tags for a given user or user 202 within a specific epoch. Efficient lookups can be performed on the ledger 206 to retrieve relevant transactions specific to individual users. The auditor 208 can analyze retrieved transactions without compromising user privacy outside the audited scope.

The intermediaries 204 can handle some computation for the users 202. The intermediaries 204 can include a broker, a bank, an agent, any other institution, a governmental agency, etc. Intermediaries 204 handle computations on behalf of users and can generate and store User Tag Keys (UTK) for each user as well as create proofs to demonstrate the validity of UTKs. The intermediaries 204 do not store any secret key. The intermediaries 204 can communicate with a registration authority 210 (RA) to verify and sign user credentials. The intermediaries 204 can also provide information to the auditor 208 upon authorized requests.

All parties are registered with the registration authority 210. The registration authority 210 can maintain mappings between users 202 and their intermediaries 204 and between users, their unique identifiers (UIDs), and public keys. The registration authority 210 is equipped with a signing key-pair (ssk_{RA}, spk_{RA}), where ssk is a signing secret key and spk is a signing public key. The registration authority 210 can issue and manage anonymous credentials for users and can verify proofs from the intermediaries 204 and sign user credentials. The registration authority 210 can be equipped with a signing key-pair for credential issuance.

The transaction system 200 incorporates epoch-based transaction processing to enable efficient auditing and parallelism. Bounded indices limit the number of transactions per user per epoch. Epoch-specific keys are generated with zero-knowledge proofs to maintain privacy while enabling verification. Anonymous credential systems (e.g., IDEMIX®) preserve user anonymity. Cryptographic commitments bind user attributes to transactions without revealing the users to the auditor 208. The transaction system can provide a balance between privacy preservation and auditability, to allow efficient and secure processing of transactions while enabling authorized and private auditing when needed.

In accordance with a practical example, a verifiable tagging scheme in a transaction system will now be described. A user 202 on-boards at the registration authority 210 and intermediary 204. A transaction is generated by the user, which needs to sign the transaction. A tag is created for each transaction and attached to it. The transaction is processed, and each transaction is tracked on the ledger 206. The ledger 206 guarantees uniqueness of the tags. In the event of an audit, the auditor 208 receives keys for the audited users and epochs, reconstructs the user tags and quickly looks up transactions.

The registration authority 210 is responsible for on-boarding users. At the end of the user onboarding, the user gets a credential. This can be done as part of the IDEMIX® onboarding process. At the end of the onboarding, the user gets a credential with some attributes attached to the credential, among the credentials is the user's UID.

Then, the user is on-boarded by their intermediary 204. At the time of registration at the intermediary 204, the user communicates its UID to the intermediary 204. The intermediary 204 computes the following User Tag Key-Pair, and proof:
tk_{U}=KDF (sk_{I},uid) (e.g., Hash-based Key Derivation Function (HKDF)/Hash-based Message Authentication Code (HMAC)),
ptk_{U}=g^{tk}^{_{U}}, where ptk_{U} is a pairwise transient key and g is generator element used in various cryptographic protocols and operations, such as key generation, encryption, or digital signatures, and
πₜₖ=NIZK{tk_{U}:ptk_{U}=g^{tk}^{_{U}}}

The KDF is used for space efficiency. The intermediary 204 can pick tk_{U} at random for each user and store it. The proof πₜₖ can be a zero-knowledge proof (ZK proof), computed using a general purpose ZK proof system. Then, the intermediary sends (ptk_{U}, πₜₖ) to the registration authority 210.

The registration authority 210 verifies πₜₖ and sends a signature:

o=SIGN (ssk_{RA},(uid,ptk_{U},xₘₐₓ)) to the intermediary 204. The intermediary sends tkᵤ and the signature σ to the user 202.

For transaction generation, at the beginning of each epoch, the user 202 computes the epoch-based Tag Generation Key in the following way:

$${tk}_{U}^{epoch} = KDF ( {tk}_{U} , epoch ) .$$

At time of transaction preparation, the user 202 assembles a transaction with transaction ID, txID. When this is done, the user 202 prepares the tag to attach to the transaction and the IDEMIX® signature. The user samples a random value x in 0≤x<xₘₐₓ and computes tag

$$T = ( {tk}_{U}^{epoch} , x ) .$$

Then, the user computes the IDEMIX® signature over the transaction and tag T, and commits to their UID: Comm_{UID}=Comm(UID;r_{UID}).

Then, the user proves in ZK the following:

$${π}_{T} = \{ {tk}_{U}^{epoch} , {tk}_{U} , x , σ , {x}_{max} , uid , {r}_{UID} : {tk}_{U}^{epoch} = KDF ( {tk}_{U}^{epoch} , epoch ) ∧ T = HMAC ( {tk}_{U}^{epoch} , x ) ∧ 0 \leq x < {x}_{max} ∧ VER ( {spk}_{RA} , σ , ( uid , {ptk}_{U} , {x}_{max} ) ) = 1 ∧ {ptk}_{U} = {g}^{{tk}_{U}} ∧ {Comm}_{UID} = Comm ( UID ; {r}_{UID} ) \}$$

where NIZK is a non-interactive zero-knowledge proof.

Tag T and proof π_{T} are appended to the transaction together with the IDEMIX® signature. The user 202 sends the transaction to the ledger 206.

During transaction processing, the ledger 206 first checks that tag T does not equal the tag of any previous transaction present in the ledger 206. The ledger 206 then verifies the NIZK proof and accepts the transaction if the tag proof is verified in addition to any other required check.

In the event of an audit, the auditor 208 provides the intermediary 204 with the target UID of user U and an epoch. The intermediary provides

$${tk}_{U}^{epoch} ,$$

and the proof:

$$NIZK \{ {tk}_{U} : VER ( {spk}_{RA} , σ , ( uid , {ptk}_{U} , {x}_{max} ) ) = 1 ∧ {tk}_{U}^{epoch} = KDF ( {tk}_{U}^{epoch} , epoch ) ∧ {ptk}_{U} = {g}^{{tk}_{U}} \} ,$$

where VER is a Verifiable Encryption, which is a cryptographic primitive that allows a user to encrypt revocation information in a way that can be verified by other parties without revealing the underlying data.

The auditor 208 verifies the proofs and uses the epoch tag key

$${tk}_{U}^{epoch}$$

to compute all possible tags in the target epoch. Namely, the auditor 208 does the following: For each x in [0,xₘₐₓ], compute

$$T = HMAC ( {tk}_{U}^{epoch} , x ) .$$

For each T so computed, the auditor 208 performs a lookup over the ledger 206 to retrieve the corresponding transaction. The auditor 208 receives the set of transactions submitted by the user 202 in the target epoch.

Efficiency is achieved in accordance with embodiments of the present invention by low storage requirements, e.g., the auditor 208 does not have to store anything prior to auditing a user. Efficient computation is achieved since the auditor 208 computes xₘₐₓ tags and can quickly look up the relevant transactions. The auditor 208 does not need to go through the entire ledger 206. Efficient transactions are achieved since the index or epoch system allows parallelism of transactions. Security and privacy guarantees are put in place by making transactions that are unlinkable, unframeable and with no tag duplication. Fine-grained auditing is achieved since an auditor 208 cannot compute the tags of a user that the auditor 208 is not allowed to audit, and the auditor 208 can only audit a user for a given epoch, not outside the epoch unless permitted.

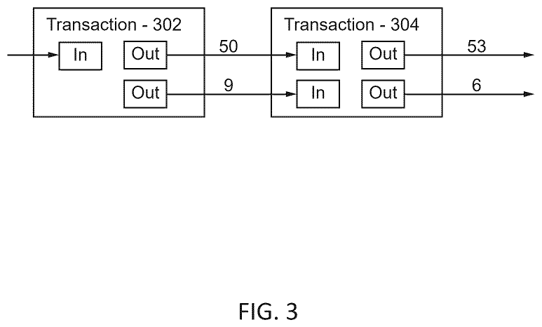

Referring to FIG. 3, in transactions where there are senders and recipients, such as, e.g., in software transactions, both sender and recipient transactions need to be tracked. In an example, a ledger-based UTXO payment system can be described. UTXO refers to Unspent Transaction Output. UTXO is a model used in blockchain and cryptocurrency systems to track and manage the ownership of digital assets. In a UTXO-based system, each transaction consumes one or more previously unspent outputs and creates new unspent outputs. Tagging can be performed in the UTXO payment system when a transaction carries any other identities. In a payment system, each transaction carries information about a sender and a recipient. Both these identities need to carry a tag for later auditing. In this setting, recipients may not be online. In this case, intermediaries can compute the tags on behalf of their clients. To do so, the intermediaries store what is necessary to compute the tags. UTXO-based payment transaction potential currency owners can be assigned a pair of public and private addresses.

Issue transactions can have null inputs and outputs that include an array of, e.g., CBDC tokens (a CBDC token is a digital representation of a Central Bank Digital Currency). A token defines ownership using public addresses (e.g., owner (public address)) and values). An issuer (issuer (central bank)) provides a signature for the issue transaction. An issue transaction validation can include verifying the signature and adding outputs, if the signature is valid.

Spend transactions 302, 304 use outputs from previous transactions as inputs. Spend transactions 302, 304 generate an array of tokens (indicated as numbers on the arrows) as outputs as well and include signatures from the owners of the input tokens. Spend transaction validation includes verifying the validity of signatures and ensuring value preservation across inputs and outputs (note the token count is equal before and after transaction 304). Spend transactions 302, 304 need to have a way of detecting and preventing double spending and removing spent inputs and adding new outputs to a ledger. This allows for efficient tracking of token ownership and transfer while maintaining the integrity of the transaction system.

For UTXO-based payment transactions, potential owners of currency are each assigned a pair of public and private addresses.

Issue transactions include inputs that are null; outputs can be an array of CBDC tokens, where the token defines owner (public address) and value.

### Issuer (Central Bank)'s Signature:

Validation rules: if signature is valid, add outputs.

Spend transactions include inputs that are outputs from previous transactions and outputs can be an array of tokens.

### Signatures are of Inputs' Owners:

Validation rules: if signatures are valid and value is preserved, and inputs were not spent before (double spending detection), then delete inputs and add outputs.

Privacy-preserving UTXO-based transactions can be provided in accordance with the embodiments of the present invention. A token, which can represent currency or any other resource, is a hiding commitment: commit (id, value, SN), where id is the unique identifier of the owner, which is uniquely bound to a public key PK through a certificate issued by a registration authority; value is the value of the transaction; SN is a serial number that uniquely identifies the token (only known to the owner). Serial numbers are revealed at time of spending and help detect double spending. Zero-knowledge proofs show the value is preserved (the sum value of the inputs match the sum value of the outputs), and the tokens being consumed are recorded in the issuer's ledger (the issuer signs the tokens in the ledger and their owners fetch the signature in a privacy-preserving manner). Zero-knowledge proofs also show that the revealed serial numbers are the serial numbers of the inputs. Anonymous signatures prove ownership without revealing the identities of the owners.

Tagging a privacy-preserving UTXO transaction in accordance with embodiments of the present invention can include the following:

For each input, the corresponding signature must carry a tag. This is a sender tag.

For each output, the output must carry a tag. This is a recipient tag. One recipient can be the sender.

### Computing the Tags:

For the sender tags, follow the process described with reference to FIG. 1.

For each recipient tag, prove that the tag refers to the identity store in the corresponding output. Note: that an output is commit (id, value, SN), therefore IT will refer to this commitment. Value and SN are part of the witness for this ZK proof.

If the recipient is not online to generate the tag, the recipient's intermediary can generate the tag on behalf of the recipient. This is possible since the intermediary stores tk_{U} and the registration authority's signature.

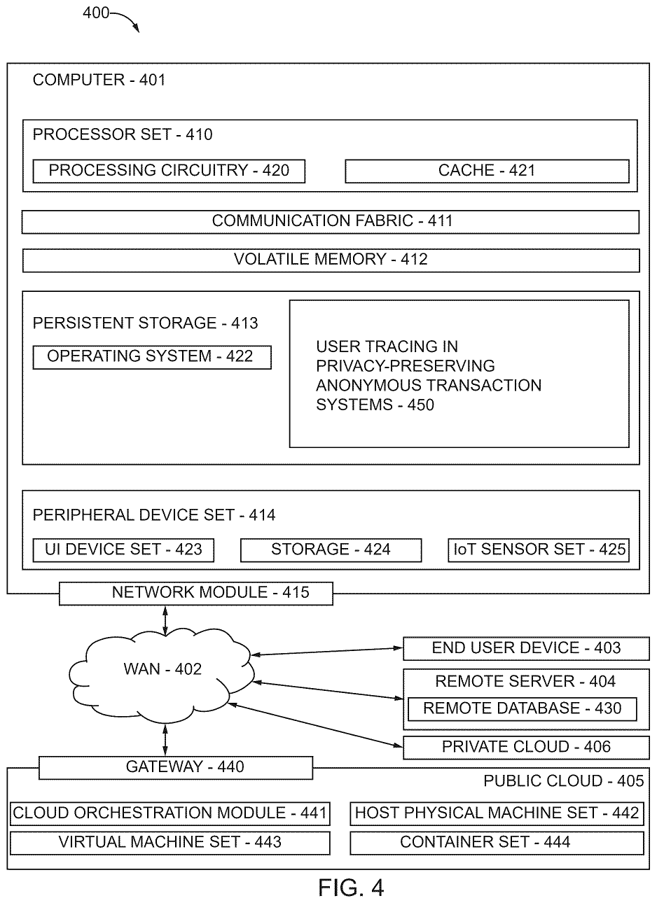

Referring to FIG. 4, a computing environment 400 contains an example of an environment for the execution of at least some of the computer code involved in performing the inventive methods, such as, user tracing in privacy-preserving anonymous transaction systems in block 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid-state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer, and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

Cloud computing services and/or microservices (not separately shown in FIG. 4): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, and laptops), through the Internet, to the provider's systems, and back. In some embodiments, cloud services can be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs (Application Programming Interfaces). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on-demand, and virtual private networks.

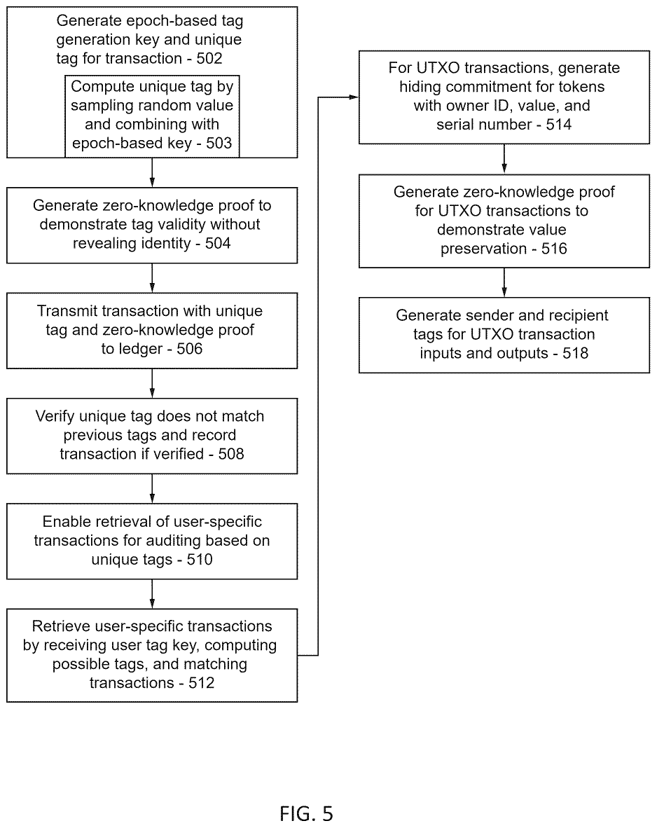

Referring to FIG. 5, a system/computer-implemented method for user tracing in privacy-preserving anonymous transaction systems in accordance with embodiments of the present invention is shown and described. In block 502, a user device generates an epoch-based tag generation key for a current epoch and a unique tag for a transaction using the epoch-based tag generation key. The epoch-based tag generation key can be derived using a key derivation function based on a user tag key and an epoch number. In block 503, computing the unique tag can include sampling a random value and combining the random value with the epoch-based tag generation key. In block 504, a zero-knowledge proof is generated by the user device to demonstrate validity of the unique tag without revealing user identity. The number of transactions per user per epoch is limited to a predefined maximum value.

In block 506, the transaction with the unique tag and zero-knowledge proof are transmitted to a ledger. In block 508, the ledger verifies that the unique tag does not match any previous transaction tags and records the transaction on the ledger if the unique tag and zero-knowledge proof are verified. In block 510, retrieval of user-specific transactions for auditing purposes are enabled based on the unique tags. In block 512, the retrieval of user-specific transactions can include receiving, by the auditor, a user tag key for a specific user and epoch from an intermediary. Possible tags are computed for the specific user and epoch and transactions can be retrieved from the ledger that match the possible tags. The auditor can verify that the user tag key corresponds to a target user identifier.

In block 514, when the transaction is a UTXO based transaction, a hiding commitment can be generated for each token in an array of tokens, wherein the hiding commitment includes a unique identifier of an owner, a value, and a serial number. In block 516, a zero-knowledge proof can be generated demonstrating that a sum value of inputs matches a sum value of outputs without revealing specific values, and the serial number of an input token can be revealed when spending an input token to enable detection of double spending. In block 518, the unique tag can be generated as a sender tag for each input of the UTXO-based transaction and a recipient tag for each output of the UTXO-based transaction. Each recipient tag refers to an identity stored in a corresponding output commitment and can be proven without revealing the identity. An intermediary can generate the recipient tag on behalf of a recipient when the recipient is not online.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method, comprising:
generating, by a user device, an epoch-based tag generation key for a current epoch and a unique tag for a transaction using the epoch-based tag generation key;
generating a zero-knowledge proof to demonstrate validity of the unique tag without revealing user identity;
transmitting the transaction with the unique tag and zero-knowledge proof to a ledger;
verifying, by the ledger, that the unique tag does not match any previous transaction tags;
recording the transaction on the ledger if the unique tag and zero-knowledge proof are verified; and
enabling retrieval of user-specific transactions for auditing purposes based on the unique tag.

2. The method of claim 1, wherein computing the unique tag comprises:
sampling a random value; and
combining the random value with the epoch-based tag generation key.

3. The method of claim 1, wherein the epoch-based tag generation key is derived using a key derivation function based on a user tag key and an epoch number.

4. The method of claim 1, further comprising:
limiting a number of transactions per user per epoch to a predefined maximum value.

5. The method of claim 1, wherein enabling retrieval of user-specific transactions comprises:
receiving, by an auditor, a user tag key for a specific user and epoch from an intermediary;
computing possible tags for the specific user and epoch; and
retrieving transactions from the ledger matching the possible tags.

6. The method of claim 5, further comprising:
verifying, by the auditor, that the user tag key corresponds to a target user identifier.

7. The method of claim 1, wherein the transaction is an Unspent Transaction Output (UTXO) based transaction, and the method further comprises generating a hiding commitment for each token in an array of tokens, wherein the hiding commitment includes a unique identifier of an owner, a value, and a serial number.

8. The method of claim 7, further comprising:
generating a zero-knowledge proof demonstrating that a sum value of inputs matches a sum value of outputs without revealing specific values; and
revealing the serial number when spending an input token to enable detection of double spending.

9. The method of claim 8, wherein computing the unique tag comprises:
generating a sender tag for each input of the UTXO based transaction; and
generating a recipient tag for each output of the UTXO based transaction.

10. The method of claim 9, further comprising:
proving that each recipient tag refers to an identity stored in a corresponding output commitment without revealing the identity.

11. The method of claim 9, wherein an intermediary generates the recipient tag on behalf of a recipient when the recipient is not online.

12. A system, comprising:
a processor set;
one or more computer-readable storage media; and
program instructions stored on the one or more computer-readable storage media to cause the processor set to perform operations comprising:
generating an epoch-based tag generation key for a current epoch;
computing a unique tag for a transaction using the epoch-based tag generation key;
appending the unique tag to the transaction;
transmitting the transaction with the unique tag to a ledger;
verifying that the unique tag does not match any previous transaction tags stored on the ledger; and
enabling retrieval of user-specific transactions for auditing purposes based on the unique tag.

13. The system of claim 12, wherein the operations further comprise:
generating a zero-knowledge proof demonstrating validity of the unique tag without revealing user identity.

14. The system of claim 12, wherein the operations further comprise:
limiting a number of transactions per user per epoch to a predefined maximum value.

15. The system of claim 12, wherein enabling retrieval of user-specific transactions comprises:
receiving a user tag key for a specific user and epoch from an intermediary;
computing possible tags for the specific user and epoch; and
retrieving transactions from the ledger matching the possible tags.

16. The system of claim 15, wherein the operations further comprise:
verifying that the user tag key corresponds to a target user identifier.

17. The system of claim 12, wherein the operations further comprise: computing the unique tag by:
generating a sender tag for each input of an Unspent Transaction Output (UTXO) based transaction; and
generating a recipient tag for each output of the UTXO based transaction.

18. The system of claim 17, further comprising:
proving that each recipient tag refers to an identity stored in a corresponding output commitment without revealing the identity.

19. The system of claim 17, wherein an intermediary generates the recipient tag on behalf of a recipient when the recipient is not online.

20. A computer program product, comprising:
one or more computer-readable storage media; and
program instructions stored on the one or more computer-readable storage media to perform operations comprising:
generating an epoch-based tag generation key for a current epoch;
computing a unique tag for a transaction using the epoch-based tag generation key;
appending the unique tag to the transaction;
transmitting the transaction with the unique tag to a ledger;
verifying that the unique tag does not match any previous transaction tags stored on the ledger; and
enabling retrieval of user-specific transactions for auditing purposes based on the unique tag.
